(19) United States
(12) Patent Application Publication
(10) Pub. No.: US 2004/0249849 A1
(43) Pub. Date: Dec. 9, 2004

(54) Conversion system

(76) Inventor: Michael Mordkovich, Marblehead, MA (US)

Correspondence Address: George E. Kersey, P.O. Box 1073, Framingham, MA, 01701, US

(21) Appl. No.: 10/456,398

(22) Filed: Jun. 5, 2003

(51) Int. Cl. G06F 7/00

(52) U.S. Cl. 707/102

(57) ABSTRACT

Method and apparatus for automatic generation of a Graphical User Interface (GUI) from an existing Command Line Interface (CLI) by automatically propagating any changes in CLI to GUI so that a user will be provided with GUI-based procedures, without requiring an equipment vendor to expend the extra effort and expense that would otherwise be needed. The method and apparatus of the invention automatically builds a GUI from a CLI by automatically building a database of all commands and options available in the CLI to automatically present commands in graphical form to the user without requiring manual intervention, for example by coding.

This invention relates to the conversion of one operational system to another, and, more particularly, to the conversion of a Command Line Interface to a Graphical User Interface.

### BACKGROUND OF THE INVENTION

Processor controlled systems and devices are now in common use. Among such processor controlled systems are computers, communications and networking devices, industrial automation systems and many others.

Such systems and devices require human input to configure, control, and monitor their operations. Developers of these systems have provided sets of commands that can be entered through a control terminal. Typically, at a system prompt, a user enters one or several commands to achieve desired operational characteristics.

The result is a Command Line Interface (CLI) which is commonly provided. To make a CLI more user friendly, additional features are added from time to time. Among the added features are provisions for “help” and “input verification”.

However, many CLI commands are complex, consisting of many keywords and arguments, with many options. To assist a user in the selection of an appropriate command, the user can invoke the “help” facility at any point in the operation of a system. By typing a question mark “?” or the letter “h”, the user receives prompts about all available options for the current operation.

Advances in computers and their operating systems have made available new means of user/computer interactions. In addition to keyboards and keypads, all modern computers include a mouse or a similar pointing device.

The availability of pointing devices, along with software, allows for the implementation of other interaction techniques on commonly used operating systems, including MS Windows and UNIX.

Accordingly, it became possible to be able to provide a Graphical User Interface (GUI) on commonly used operating systems. A GUI provides many benefits as compared with a Command Line Interface. A GUI is more intuitive, easier to use and navigate, quicker, and less prone to user input errors. It is, therefore, more user friendly. As a result, users desire GUI-based tools to configure and control equipment. This does not mean that a GUI can replace a CLI since CLI-based interactions between the user and equipment are also needed at a lower level for close and direct control of equipment.

As a result, when both CLI and GUI facilities are needed, equipment manufacturers incur extra effort and extra expense in order to provide both CLI and GUI facilities. Thereafter, any change in equipment requires changes in both types of systems, making product support more difficult and costly over time.

Accordingly, it is an object of the invention to expedite the inclusion of both CLI and GUI facilities in processor controlled devices and systems. A related object is to supplement a Command Line Interface with a Graphical User Interface. Another related object is to facilitate the conversion of a Command Line Interface to a Graphical User Interface.

A further object of the invention is to reduce the complexity of creating and maintaining systems employing both a Command Line Interface and a Graphical User Interface.

Still another object of the invention is to supplement the benefit provided by a Command Line Interface with a Graphical User Interface. A related object is to take advantage of the benefits provided by a Graphical User Interface.

### SUMMARY OF THE INVENTION

In accomplishing the foregoing and related objects, the invention provides for automatic generation of a Graphical User Interface (GUI) from an existing Command Line Interface (CLI).

In accordance with one aspect of the invention, any commands available in the CLI will also be automatically propagated to the GUI. As a result, a user will be provided with GUl-based procedures, without requiring an equipment vendor to expend the extra effort and expense that would otherwise be needed.

In accordance with another aspect of the invention, the method and apparatus of the invention automatically build a GUI from a CLI, starting with automatically building a Data Base of all commands and options available in the CLI. For that purpose, a special Data Base Builder module is implemented. This module generates the Data. Base that allows automatic presentation of commands in graphical form to the user. Since these operations are performed automatically, they do not require manual intervention, for example by coding.

The Data Base Builder of the invention can obtain information about CLI commands and their options in various ways. One way is to use the “help” facility of the CLI. All necessary commands and other help information are obtained by interrogating the CLI. Starting from the initial CLI prompt, all necessary commands are requested. Once these commands are returned by the CLI, the Data Base Builder obtains information about all options for each command by requesting “help” for each. This process is repeated until all options for all commands are obtained and stored in the Data Base

Any other method can be used to have the CLI display all of its commands and capture its output. In another approach, the CLI source code files can be accessed directly and scanned to retrieve, all necessary and pertinent information.

The Data Base of all available commands is used by another module of the invention—a Data Visualization Module which presents commands in visual/graphical form and allows the user to select any of the commands presented, and their options.

The World Wide Web can be employed to allow the user to access a device under control. Any commercially available Web Browser, for example a Netscape Browser or the MS Internet Explorer, can be used. The Browser will provide both communication with the device, and an application platform and environment. Alternatively, the user interface also can be presented by any other stand-alone application that is running on a workstation, which is local or remote to the device that it controls.

The apparatus of the invention can be provided by commonly employed computers and can automatically generate a Graphical User Interface (GUI) from a Command Line Interface (CLI), by means providing a Command Line Interface, means generating a Data Base for commencing the conversion of CLI operations to GUI operations, means completing the conversion of CLI commands to GUI commands after all CLI commands have been obtained and stored in the Data Base, and means presenting the commands stored in the Data Base in graphical form.

In accordance with one aspect of the apparatus, included are means for displaying available CLI commands in graphical form. Also included are means for graphically displaying all options of such commands for achieving an interface conversion by which a GUI facility is obtained from a Command Line Interface.

In accordance with another aspect of the apparatus, means are included for representing available CLI operations indicated by CLI commands as a tree with branches extending to individual commands and their options.

In accordance with a further aspect of the apparatus, means are included for automatically propagating to a GUI all commands available in the CLI, thereby providing GUI-based procedures without requiring an equipment vendor to expend the extra effort and expense that would otherwise be needed. A GUI is built from a CLI by automatically constructing a Data Base of all commands and options available in the CLI by a Data Base Builder. Means for implementing a Data Visualization Module automatically presents commands in graphical form to the user, and allows the user to select such commands, so that the automatic performance does not require manual intervention, for example by coding.

In accordance with still another aspect of the apparatus, means are included for obtaining information about CLI commands and their options in different ways, including use of the “help” facility in the CLI for interrogating the CLI, starting from an initial CLI prompt, and establishing a Data Base with information about all options for each command by requesting “help” for each, and repeating the process until all options for all commands are obtained.

In accordance with a further aspect of the apparatus, means are included for visualization or display of the commands, and their options, in graphical form and allow the user to select any of such commands

In accordance with a still further aspect of the apparatus means are used to have the CLI display all of its commands and capture its output, or means are used for accessing CLI source code files directly and scanned to retrieve all necessary and pertinent information; and the World Wide Web is used to access the device under control and provide both communication with the device and an applications platform and environment. Access to the Web can be made by a commercially available Web Browser, for example a Netscape Browser or the MS Internet Explorer, and used to provide both communication with the device, and an application platform and environment. A user interface alternatively can be presented by a stand-alone application that is running on a workstation, which is local or remote to the device that it controls.

### DESCRIPTION OF THE DRAWINGS

Other aspects of the invention will become apparent after considering a detailed description of the invention taken in consideration with the drawings, in which:

FIG. 1 is a flow chart of available Command Line Interface (CLI) operations represented by all available (CLI) commands as a tree with branches populated with individual commands and their options;

FIG. 2 is a flow chart of a Data Base Builder module or commencing the conversion of CLI commands to Graphical User Interface Commands (GUI) by building Data Base of all available CLI commands;

FIG. 3 is a flow chart of a Data Visualization Module presenting to the user, in the graphical form, completion of the conversion of CLI commands to Graphical User Interface Commands (GLI) after all commands have been obtained from the CLI and stored in the Data Base;

FIG. 4A is a graphical display of available CLI commands;

FIG. 4B is a graphical display of first level options of selected (show) commands; and

FIG. 4C is a graphical display of second level options of selected (show aliases) commands.

### DETAILED DESCRIPTION

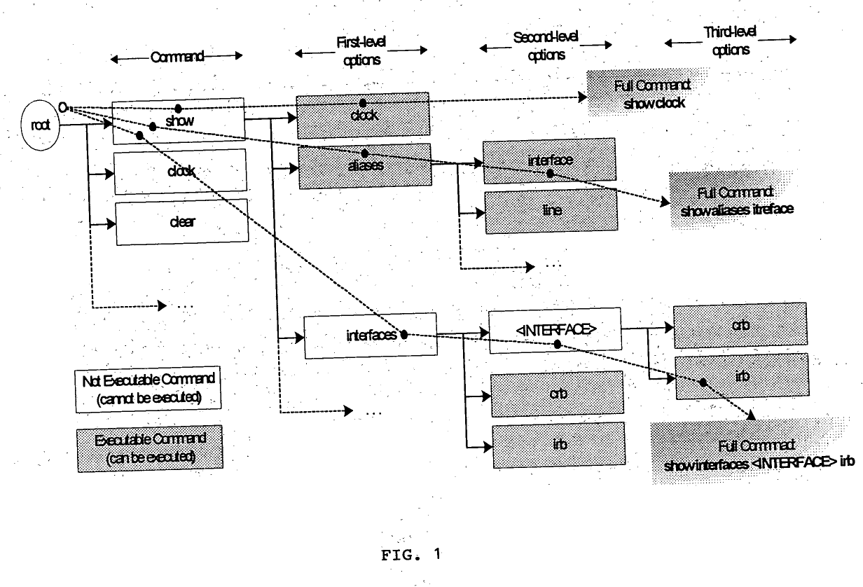

With reference to the drawings, FIG. 1 presents a partial list of available Command Line Interface (CLI) commands of a communications device as a tree with branches populated with individual commands and their options.

All CLI commands shown in FIG. 1 are collected by a “Data Base Builder” module and stored in a Data Base. The Data Base is used in the GUI-CLI conversion to present all of these commands to the user in graphical form.

As shown in FIG. 1, the CLI command tree starts with a root from which command branches extend. Many branches have other branches of their own as options, and have sub options, as well. Some commands have only a single level as indicated by a keyword. Other commands have more than one level to make them complete. Once a command is complete, it can be executed.

An illustrative, complete executable command is “show aliases interface” which stems from the command “show” to a first level option command “aliases” to a second level option command “interface” for which the final result is the full command “show aliases interface”.

This procedure is summarized in FIG. 1, along a dashed-arrowed line, and can be summarized by the indicia “show”, “aliases”, and “interface”. Another illustrative executable command also indicated by a dashed-arrow line below the line discussed above, extends from “show” to “interfaces” to “INTERFACE” <stands for interface number> to “irb”.

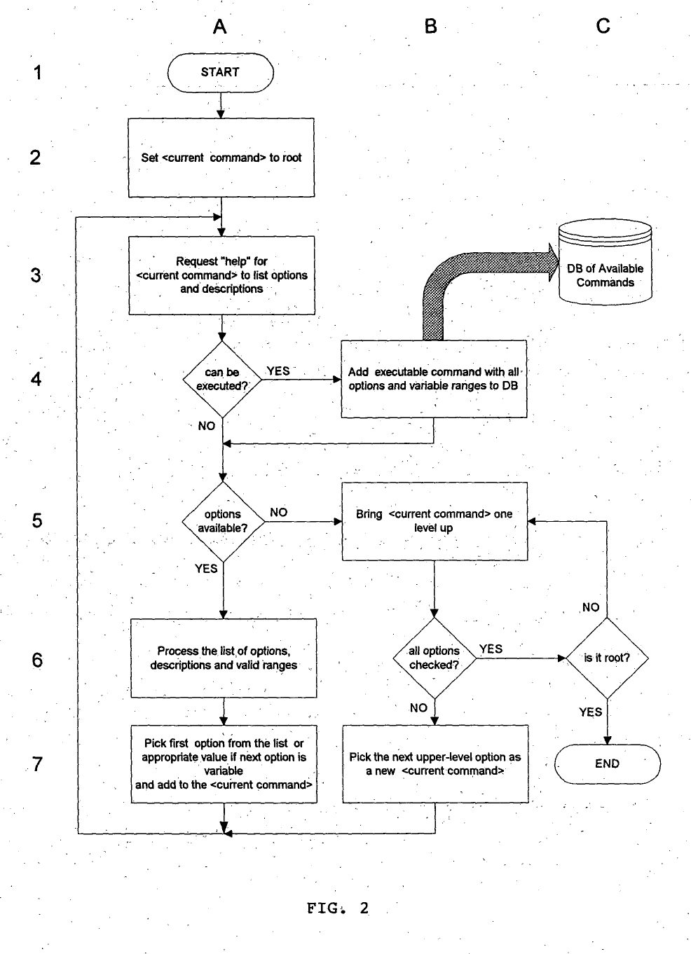

The tree-based structure of FIG. 1 allows the operation to systematically go through the hierarchy of commands and options, and obtain them for the Data Base as shown on FIG. 2, which contains a block diagram of the Data Base Builder module.

The procedure depicted in FIG. 2 starts with setting <current command> pointer to root [2,A]. Help is requested from the CLI by issuing the help or ? command [3,A]. The CLI returns a list of available options with their descriptions. In an illustrative case, this will be:

| | |
|---|---|
| show | Show running system information |
| clock | Manage the system clock |
| clear | Reset functions |

If a command can be executed, one of the returned options is a Carriage Return symbol. The procedure checks whether the command (show in the present case) can be executed [4,A]. The result is negative, and a check is made to determine whether there are any available options by the show ? command. Options are available, and CLI will return:

| | |
|---|---|
| show clock | Display the system clock |
| show aliases | Display alias commands |
| show interfaces | Interface status and configuration |

The options are stored-and processed, along with valid ranges for options that are to be entered by the user [6,A]. The first option is picked from the list [7,A] and added to the <current command> show clock. The operation returns to [3,A] and requests help show clock ?. This will return Carriage Return symbol only, which means that this is a complete and executable command. It checks whether it is an executable command [4,A], which is true, and the show clock command is added to the Data Base [4,B].It then checks whether any options are available for this command [5,A], which is false. The <current command> is brought one level up [5,B], which makes it show. A check is then made whether all available options are processed. This is false, and the next available option, aliases, is added to the show command. The process then goes [3,A] to request, help show aliases ?. The CLI will return:

| | |
|---|---|
| show aliases interface | Interface configuration mode |
| show aliases line | Line configuration mode |

This is not an executable command and check [4,A] will be negative. A check is then made whether there are any options, which is true. The list of options is processed [6,A] and the first option interface [7,A] is picked. The procedure then goes back [3,A] and the show aliases interface ? command is issued. CLI responds by only returning the Carriage Return symbol. A check [4,A] will be true, and this command will be added to the Data Base [4,B]. There are no options available for the show aliases interface command and a check [5,A] will be false. Then the <current command> is brought up one level [5,B] to show aliases. A check is then made whether there are more options available [6,B], which is true. The next available option is picked, which is line that is added to the show aliases command.

This processing is repeated until all available CLI commands, and their options ,are stored in the Data Base [2,B] and ready to be presented in a graphical form.

In the present example the Data Base Builder module uses CLI Help to obtain information on all the commands and their options. The process starts from the initial CLI prompt and requests all the available commands. Once these commands are returned by the CLI, the Data Base Builder receives information about all options for each command by requesting help. This process is repeated until all options for all the commands are obtained by the module. There may be other means to cause CLI to issue its available commands or this information can be obtained directly from CLI source code. In either case there will be an algorithm similar to the one depicted in FIG. 2 to process this information and to store it in the Data Base for visualization.

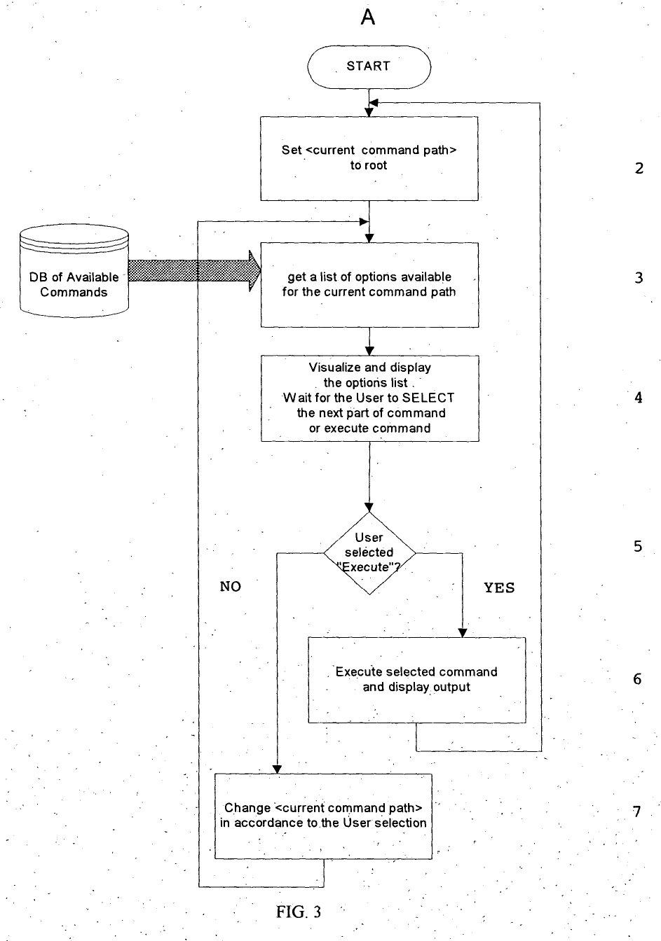

Once all the commands are obtained from the CLI and stored in the Data Base, they can be presented to the user in the graphical form. It is done by a Visualization Module for which a block diagram is presented in FIG. 3.

The Data Base, contains the hierarchy of the CLI commands which reflect the command tree depicted in the FIG. 1. The Visualization module sets <current command path> to root [2,A], and then obtains from the Data Base the list of options available for the <current command path>[3,A]:

| | |
|---|---|
| show | Show running system information |
| clock | Manage the system clock |
| clear | Reset functions |

These commands get displayed, and the module waits for user input, such as the click of a mouse on any of the displayed commands [4,A]. A check is made whether the selected command is executable [5,A]. Assuming that the user clicked on the show command, this is not executable and the “check” [5,A] will be false. The <current command path> will be changed to this command and a list of options for the command will be provided [3,A]. The options for the show command are:

| | |
|---|---|
| clock | Display the system clock |
| aliases | Display alias commands |
| interfaces | Interface status and configuration |

These are displayed, and the user selects an option from the list [4,A]. Assuming that the user clicked on the aliases option, show aliases is not executable the “check” [5,A] will be false. The <current command path>will be changed to this command and will list the options for the command [3,A]. The options for show aliases are:

| | |
|---|---|
| interface | Interface configuration mode |
| line | Line configuration mode |

These are displayed, and the user selects an option from the list [4,A]. Assuming that the user clicked on the interface option, show aliases interface is an executable command and the “check” [5,A] will be true, sending the command to the device it controls as if this command was manually entered by the user at the control terminal at the CLI prompt [6,A]. The output of the command by CLI is displayed on the screen.

After that <current command path> is set to root [2,A] and the system is ready to accept and execute the next command.

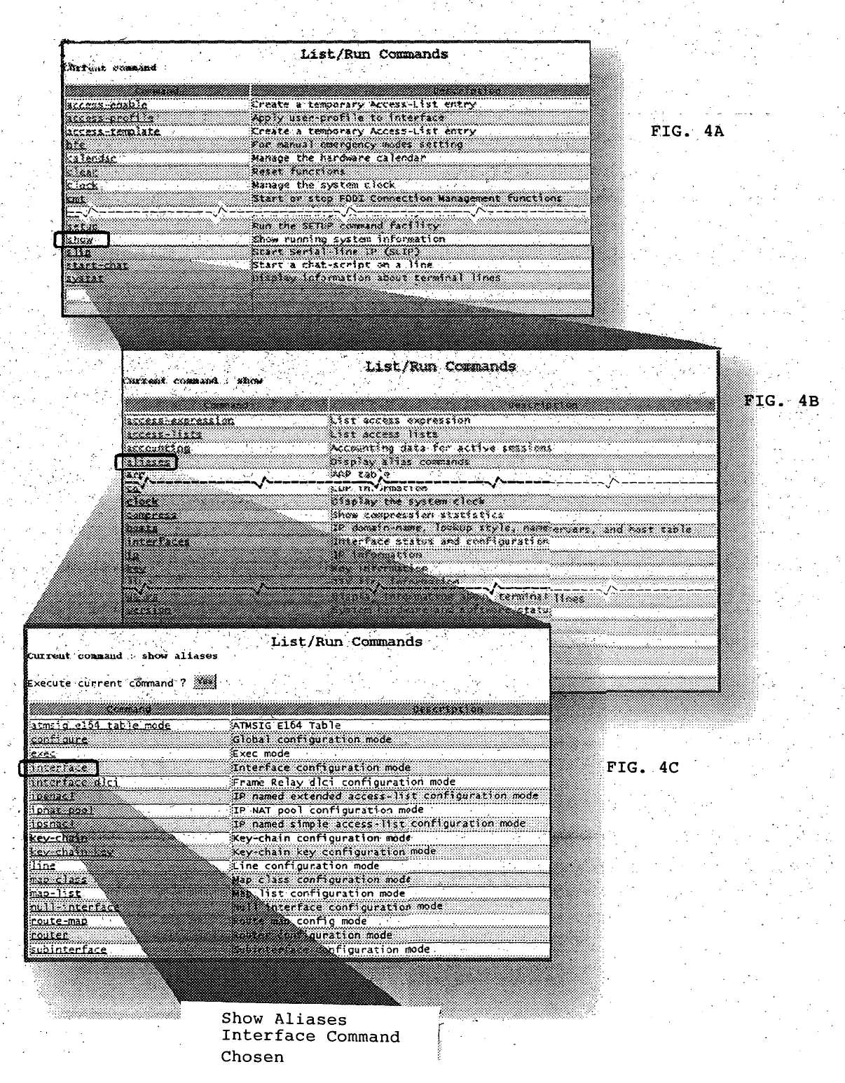

An example of a Graphical CLI display is shown in FIGS. 4A, 4B and 4C, with 3 pages captured from a WEB browser display. The first page of FIG. 4A displays the commands as shown in FIG. 1. It has show, clock, clear and other commands available from the root. It also displays help information about each of the commands obtained from CLI. Clicking on a command (show in our case) bring us to the second page of FIG. 4B. It displays current command show on the top of the page and all the options available for the command. One of the options is aliases. Clicking on this option bring us to the third page of FIG. 4C which displays the options available for show aliases command. If the user selects and clicks on an executable command this causes the command to be executed by sending the command to CLI as if the user typed it in at the control terminal. In our case the command sent to CLI would be show aliases interface

All the user had to do is navigate the browser windows by clicking on the command and its options.

Once the Data Base with all the commands, options, and information about them is built other useful features can be added to the system. One is a search for information based on a key word. For example search for a word clock will return all the commands that can be used to control various clocks.

Another feature of the invention is to combine multiple CLI commands together. Often it requires more than a single CLI command to accomplish a task. For example it takes many CLI commands to configure a port of a communication device. And the same multiple commands are repeated over and over again for many ports. This feature would create a GUI script to accomplish these tasks. The only thing the user would need to enter is a port number and click on the script name. These scripts would become an extension of existing CLI commands and will significantly simplify user work.

A further useful feature is to keep track of user activity. All commands selected and executed by the user, along with the command output, can be stored for future reference.

It will be understood that the foregoing detailed description is illustrative only and that modifications and adaptations of the invention may be made by those of ordinary skill in the art without departing from the spirit and scope of the invention as set forth in the appended claims.

What is claimed:

1. The method of automatic generation of a Graphical User Interface (GUI) from a Command Line Interface (CLI), comprising the steps of:
(a) generating a Data Base Builder for commencing the conversion of CLI commands to a GUI and building a Data Base of said commands;
(b) obtaining available commands and their options from a CLI; and
(c) generating a Visualization module for completing the conversion of CLI commands to GUI commands after all CLI commands have been obtained and stored in said Data Base.

2. A method as defined, in claim 1 further including the step of using all available Data Base commands by said Visualization module.

3. A method as defined in claim 1 further including the step of obtaining, information about CLI commands, and their options, in a plurality of different ways.

4. A method as defined in claim 1 further including the step of graphically displaying operations represented by commands responding to alias commands for achieving an interface conversion mode by which a GUI facility has been obtained from a Command Line Interface.

5. A method as defined in, claim 1 further including the step of representing available CLI operations in hierarchical form.

6. A method as defined in claim 1 further including the step of automatically propagating to a GUI any and all CLI commands and their options, thereby to provide GUI-based procedures, without requiring an equipment vendor expense that, would otherwise be needed.

7. A method as, defined in claim 1 further including the step of automatically building a GUI from a CLI by automatically building a Data Base of all commands and options available in the CLI.

8. A method as defined in claim 7 further including the step of implementing a Data Base Builder which automatically obtains and stores in said Data Base all available CLI commands.

9. A method as defined in claim 8 further including the step of obtaining information about CLI commands and their options in different ways, including use of the “help” facility in the CLI.

10. A method as defined in claim 9 further including the step of obtaining necessary commands and help information by interrogating the CLI, starting from an initial CLI prompt, and establishing a Data Base Builder with information about all options for each command by requesting “help” for each, and repeating the process until all options for all commands are obtained.

11. Apparatus for automatic generation of a Graphical User Interface (GUI) from a Command Line Interface (CLI), comprising:
means for interrogating a Command Line Interface;
means for generating a Data Base for commencing the conversion of CLI operations to GUI operations; and
means for completing the conversion of CLI commands to GUI commands after all CLI commands have been obtained and stored in said Data Base Builder.

12. Apparatus as defined in claim 11 further including means for displaying operations represented by commands.

13. Apparatus as defined in claim 11 further including means for graphically displaying operations represented by alternative commands.

14. Apparatus as defined in claim 11 further including means for graphically displaying operations represented by commands responding to aliases.

15. Apparatus as defined in claim 11 further including means for representing available CLI operations hierarchically.

16. Apparatus as defined in claim 11 further including means for automatically propagating to GUI all available CLI, thereby to provided GUI-based procedures, without requiring an equipment vendor to expend the extra effort and expense that would otherwise be needed.
